(19) United States
(12) Patent Application Publication
(10) Pub. No.: US 2010/0053971 A1
(43) Pub. Date: Mar. 4, 2010

(54) Asymmetric Lighting Systems and Applications Thereof

(75) Inventors: Januk Aggarwal, New Albany, OH (US); Yaser Abdelsamed, Granville, OH (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: ABL IP HOLDING LLC, Conyers, GA (US)

(21) Appl. No.: 12/201,946

(22) Filed: Aug. 29, 2008

(51) Int. Cl. F21V 7/07; F21S 6/00; F21V 7/00

(52) U.S. Cl. 362/277; 362/257; 362/296.01; 362/296.07

(57) ABSTRACT

The present invention provides luminaires operable to produce asymmetric light distributions. In one embodiment, a luminaire comprises a light source, an outer optic, and at least one inner optic at least partially positioned within the outer optic.

### FIELD OF THE INVENTION

The present invention relates to lighting systems and, in particular, to lighting systems providing an asymmetric distribution of light.

### BACKGROUND OF THE INVENTION

Luminaires for providing general illumination to an area are well known and often used in outdoor lighting applications including roadway and sidewalk lighting, parking lot lighting, and residential area lighting. Luminaires having symmetric light distributions can comprise a light source disposed within an external optic, wherein the external optic is designed to provide the symmetric light distribution. In one architecture, for example, a luminaire can comprise a light source disposed within a bell-shaped external optic, wherein the bell-shaped external optic provides a symmetric distribution of light to an area.

In some applications, however, a higher degree of control over light distribution from a luminaire is desirable. In some roadway lighting applications, for example, it is desirable to use luminaires having asymmetrical light distributions operable to provide the roadway and shoulder areas with higher luminous intensity in comparison with non-roadway areas such as grassy medians. Moreover, in some residential outdoor area lighting applications, it is desirable to use luminaires having asymmetrical light distributions operable to mitigate or prevent light trespass.

Asymmetric light distributions from a luminaire can presently be created through several avenues. One avenue is to design an external optic operable to create an asymmetric light distribution when a light source is disposed within the external optic. Design of an external optic operable to provide an asymmetric light distribution, however, is often cost prohibitive due to time intensive design processes that can strain engineering resources. Moreover, the design of the external optic is usually restricted to addressing a particular lighting need thereby precluding use of the design in a variety of applications.

Another avenue for producing an asymmetric light distribution from a luminaire is to externally couple a secondary optic to a primary optic, wherein the secondary optic is responsible for creating the asymmetric light distribution. A reflective bell-shaped primary optic, for example, can have a refractive secondary optic coupled thereto, wherein the refractive secondary optic produces an asymmetric light distribution. Such an arrangement is illustrated in FIG. 1. As displayed in FIG. 1, a refractive secondary optic (102) is coupled to the bottom of a reflective primary optic (100). Creating an asymmetric light distribution with this architecture has significant disadvantages as the refractive secondary optic is likely to change the EPA wind loading of the luminaire while also increasing the weight of the luminaire. Furthermore, achieving designations such as IES Full-Cutoff becomes very difficult as the refractive secondary optic can cause uplight from the luminaire.

An additional avenue for producing an asymmetric light distribution from a luminaire is to block one or more portions of light from being transmitted by the luminaire. This avenue is disadvantageous since precluding portions of light from being transmitted by the luminaire reduces the luminous flux of the luminaire leading to inefficiencies and poor optical systems.

### SUMMARY

The present invention provides luminaires operable to produce asymmetric light distributions without the foregoing structural, cost, and efficiency disadvantages. Moreover, the present invention provides methods of providing an asymmetric light distribution to an area.

In one embodiment, a luminaire comprises a light source, an outer optic, and at least one inner optic at least partially positioned within the outer optic. The outer optic of the luminaire is adapted to direct a first portion of light received from the light source and a second portion of light received from the at least one inner optic resulting in an asymmetric light distribution from the luminaire. In some embodiments, an asymmetric light distribution comprises a radially asymmetric light distribution.

Any number of inner optics may be positioned at least partially within the outer optic. One or a plurality of inner optics may be retained at least partially within the outer optic via any retention method. In one embodiment one or more inner optics are at least partially positioned within the outer optic via a mounting bracket. The mounting bracket, in some embodiments, permits lateral, longitudinal, and/or radial adjustment of one or more inner optics. In this way, the relative positioning of the inner and outer optic is easily adjustable to permit tailoring the asymmetric light distribution of the luminaire. The ability to tailor the asymmetric light distribution of a luminaire can allow the luminaire to meet the requirements of a variety of applications without the cost considerations of having to redesign the luminaire for each intended application.

These and other embodiments are presented in greater detail in the detailed description which follows.

### BRIEF DESCRIPTION OF THE FIGURES

FIG. 1 illustrates a prior art luminaire having a secondary refractive optic externally coupled to a primary reflective optic.

FIG. 2 is an elevational cut away view of a luminaire according to one embodiment of the present invention wherein a plurality of inner optics are disposed within the outer optic.

FIG. 3 is a perspective cut away view of the luminaire of FIG. 2.

FIG. 4 is a bottom plan view of the luminaire of FIG. 2.

FIG. 5 is an exploded cut away view of the luminaire of FIG. 2.

FIG. 6 is a bottom plan view of a luminaire according to one embodiment of the present invention.

FIG. 7 is an elevational cut away view of a luminaire illustrating an inner optic directing light to an outer optic for providing an asymmetric light distribution from the luminaire according to one embodiment of the present invention.

FIG. 8 is a top cut away view of the luminaire of FIG. 7 illustrating an inner optic directing light to the outer optic for providing an asymmetric light distribution from the luminaire according to one embodiment of the present invention.

FIG. 9 is an elevational cut away view of a luminaire demonstrating refraction of light from the light source by an inner optic and subsequent reflection of the light by the outer optic according to one embodiment of the present invention.

### DETAILED DESCRIPTION

The present invention can be understood more readily by reference to the following detailed description, examples, and drawings and their previous and following descriptions. However, apparatus and methods of the present invention are not limited to the specific embodiments presented in the detailed description, examples, and drawings. It should be recognized that these embodiments are merely illustrative of the principles of the present invention. Numerous modifications and adaptations thereof will be readily apparent to those of skill in the art without departing from the spirit and scope of the invention.

The present invention provides luminaires operable to produce asymmetric light distributions without the structural, cost, and efficiency disadvantages associated with prior asymmetric lighting systems.

In one embodiment, the present invention provides a luminaire comprising a light source, an outer optic, and at least one inner optic at least partially positioned within the outer optic. The outer optic of the luminaire is adapted to direct a first portion of light received from the light source and a second portion of light received from the inner optic resulting in an asymmetric light distribution from the luminaire.

The outer optic works in conjunction with the inner optic to provide an asymmetric distribution of light from the luminaire. In one embodiment, the outer optic is adapted to direct light received from the at least one inner optic and light received directly from the light source in a longitudinal or substantially longitudinal direction. In directing light in a longitudinal or substantially longitudinal direction, the outer optic, in some embodiments, directs light out of the luminaire. Moreover, the at least one inner optic, in some embodiments, is adapted to direct light received from the light source in a transverse or substantially transverse direction. In directing light in a transverse or substantially transverse direction, an inner optic is operable to provide light received from the light source to the outer optic.

As provided herein, in some embodiments, a plurality of inner optics are at least partially positioned within the outer optic. In some embodiments, for example, a luminaire comprises two, three, four, five, six, seven, or eight inner optics.

In some embodiments of a luminaire of the present invention, the at least one inner optic is adjustable. In one embodiment, for example, the at least one inner optic is longitudinally adjustable. In another embodiment, the at least one inner optic is laterally adjustable. In a further embodiment, the at least one inner optic is radially adjustable.

In some embodiments wherein a plurality of inner optics are present, the inner optics are laterally, longitudinally, and/or radially adjustable independent of one another. In other embodiments, the plurality of inner optics are not independently adjustable and adjust in concert with one another. Adjustable inner optics, in some embodiments, permit tailoring the asymmetric light distribution of luminaires of the present invention. The ability to tailor the asymmetric light distribution of a luminaire of the present invention can allow the luminaire to meet the requirements of a variety of applications without the cost considerations of having to redesign the luminaire for each intended application.

In some embodiments, an inner optic has a V-shaped structure wherein the inner optic is bent at an angle θ. In some embodiments, θ is greater than about 90°. In some embodiments, θ is less than about 90°. In another embodiment, an inner optic has a curved structure. In one embodiment, an inner optic comprises an arc having a central angle of less than about 180°, less than about 90° or less than about 60°. In another embodiment, an inner optic comprises an arc having a central angle greater than 180°.

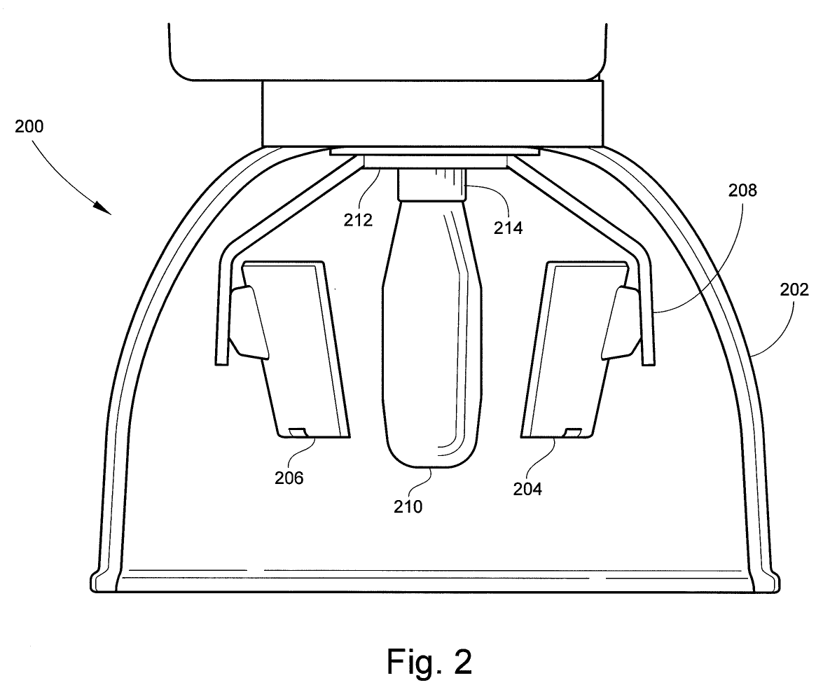

Referring now to the figures wherein like numerals indicate like elements throughout the various figures, FIG. 2 illustrates an elevational cut away view of a luminaire according to one embodiment of the present invention wherein a plurality of inner optics are disposed within an outer optic. As illustrated in a FIG. 2, the luminaire (200) comprises a bell-shaped reflective outer optic (202) having a plurality of reflective inner optics (204, 206) positioned within the outer optic (202). In the embodiment illustrated in FIG. 2, the inner optics (204, 206) are positioned fully within the outer optic (202), however they need not be positioned entirely within the outer optic (202). The reflective inner optics (204, 206) are coupled to a mounting bracket (208) for orientation around the light source (210). As provided herein, in some embodiments, the mounting bracket (208) comprises a collar (212) which surrounds the socket (214) of the light source (210) and secures to the base of the outer optic (202).

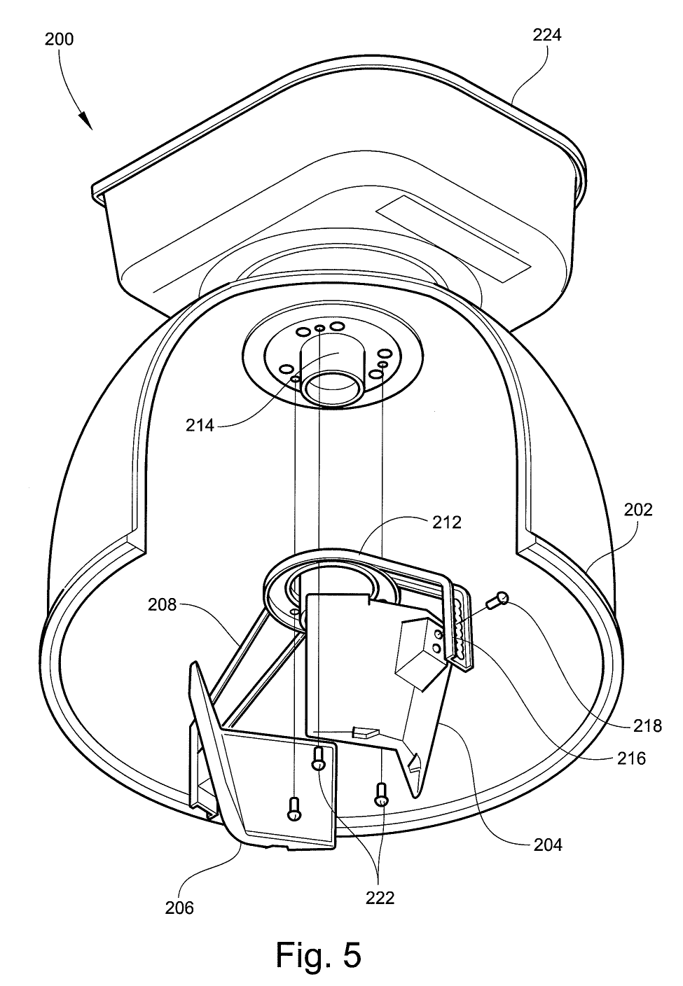

As illustrated in FIG. 5, the mounting bracket (208) couples to the outer optic (202) and the base (224) of the luminaire (200) through a plurality of bolts or screws (222). Moreover, each inner optic (204, 206) couples to the mounting bracket (208) through a bolt or screw (218). The bolt or screw (218) is inserted in one of the longitudinal settings of the slot (216) in the mounting bracket (208) to place the inner optic (204, 206) in the proper position for producing a desired asymmetric light distribution in conjunction with the outer optic (202) as described herein.

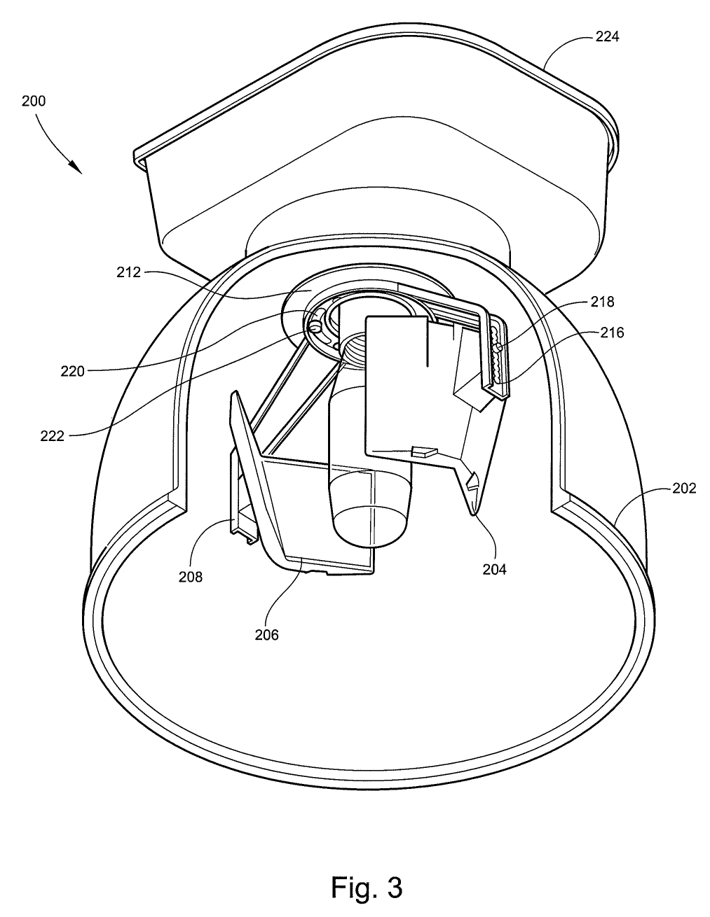

FIG. 3 illustrates a perspective cut away view of the luminaire (200). The reflective inner optics (204, 206) may be longitudinally and/or laterally adjustable on the mounting bracket (208). As illustrated in FIG. 3, the mounting bracket (208) may comprise vertical slots (216) for coupling each inner optic (204, 206) to the mounting bracket (208) with a bolt or screw (218). Each vertical slot (216) displayed in FIG. 3 has a plurality of positions or settings for longitudinal adjustment of the inner optics (204, 206). Moreover, in some embodiments, the mounting bracket (208) comprises lateral slots (not shown) comprising a plurality of positions or settings for lateral adjustment of the inner optics (204, 206).

In addition to facilitating longitudinal and/or lateral adjustment of the inner optics (204, 206), the mounting bracket (208) is operable to rotate. The collar (212) of the mounting bracket (208), for example, can comprise radial slots (220) permitting rotation of the mounting bracket (208). In one embodiment, bolts or screws (222) coupling the collar (212) to the base of the outer optic (202) and the base (224) of the luminaire (200) can be loosened and the mounting bracket (208) rotated to a desired position, the radial slots passing around the loosened bolts or screws (222) during rotation. After the desired position is achieved, the bolts or screws (222) are tightened to secure the collar (212).

In an alternative embodiment, the bolts or screws (222) can be removed and the mounting bracket (208) rotated to a new position and the bolts or screws (222) reinserted into a new position. In order to facilitate such an embodiment, the base of the outer optic (202) and the base (224) of the luminaire can have a plurality of bolt or screw (222) insertion points. As provided herein, rotation of the collar (212) results in radial adjustment of the inner optics (204, 206).

While the inner optics may be laterally, longitudinally, and/or radially adjustable independent of one another, they do not need to be independently adjustable but rather can adjust in concert with one another. Adjustable inner optics, while not required, permit tailoring the asymmetric light distribution of luminaires. The ability to tailor the asymmetric light distribution of a luminaire can allow the luminaire to meet the requirements of a variety of applications without the cost considerations of having to redesign the luminaire for each intended application.

While use of mechanical fasteners are disclosed for retaining the inner optics (204, 206) in position relative to the outer optic (202), the invention is not so limited. Rather, any retention method may be used, including, but not limited to, use of mechanical fasteners, interference fit, mechanical interlock, etc. Moreover, while the figures illustrate two inner optics (204, 206), any number of inner optics may be provided, depending on the desired light distribution. Furthermore, the geometry of the inner optics (204, 206) can be, but need not be, identical.

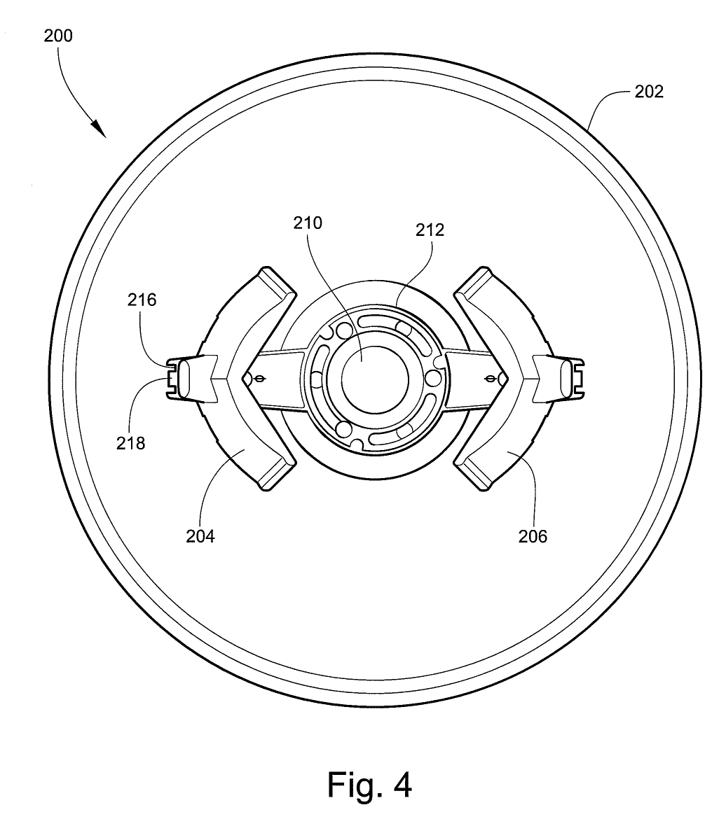

FIG. 4 displays a bottom plan view of the luminaire (200) according to one embodiment of the present invention. The inner optics (204, 206) positioned within the outer optic (202) surround up to about 180° of the circumference of the light source (210). In some embodiments, one or a plurality of inner optics surround less than about 180° of the circumference of the light source. In other embodiments, one or a plurality of inner optics surround less than about 120° or less than about 90° of the circumference of the light source. In another embodiment, one or a plurality of inner optics surround less than about 60° or less than about 30° of the circumference of the light source. In a further embodiment, one or a plurality of inner optics surround greater than about 180° of the circumference of the light source.

Moreover, the inner optics (204, 206) demonstrate one embodiment of a V-shaped structure, bent at an angle θ as provided herein. While V-shaped inner optics are illustrated in FIG. 4, inner optics having any shape tailored to reflect or refract light as desired are contemplated by the present invention. For example, linear or curved inner optics may be suitable in some applications. In one embodiment, an inner optic comprises an arc having a central angle of less than about 180°, less than about 90° or less than about 60°. In another embodiment, an inner optic comprises an arc having a central angle greater than 180°.

An inner optic, in some embodiments, comprises a reflector, refractor, or combinations thereof. In some embodiments wherein a plurality of inner optics are present, the inner optics are constructed independently of one another. In one embodiment, for example, a first inner optic is a reflector and a second inner optic is a refractor. In another embodiment, a first inner optic is a reflector and a second inner optic is a reflector. Embodiments of the present invention contemplate any combination of reflector and refractor inner optics operable to achieve asymmetric light distributions in conjunction with the outer optic.

An outer optic of a luminaire of the present invention can comprise a reflector, a refractor, or a combination thereof. In some embodiments, wherein the outer optic is a reflector, the luminaire does not produce any significant uplighting and can achieve an IES Full-Cutoff designation. While the outer optic (202) illustrated in the figures is bell-shaped, it can be of any desired shape including, but not limited to, parabolic, spherical, or elliptical.

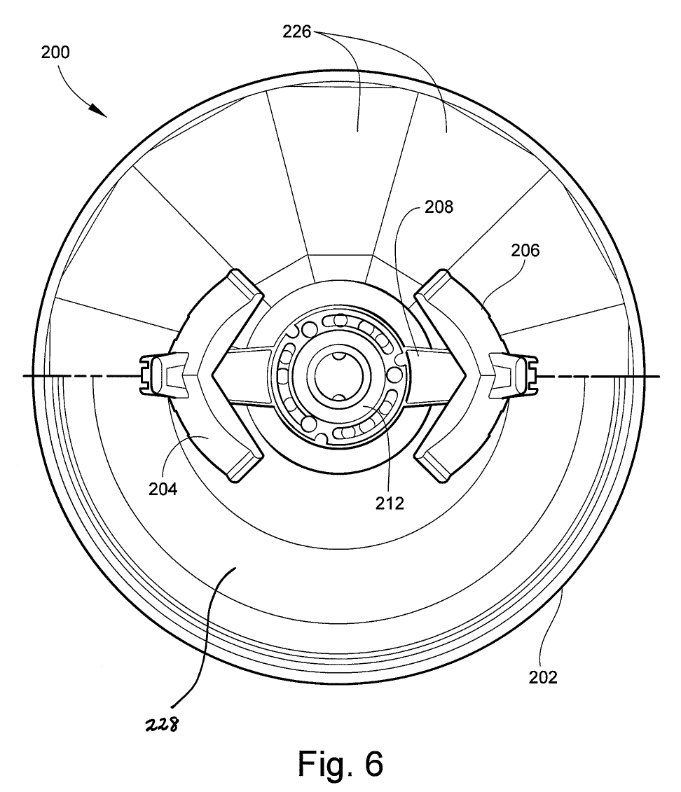

FIG. 6 illustrates an outer optic (202) having an interior surface formed of a plurality of concave panels (226). The continuous reflective surface comprising a plurality of concave panels (226) has been partially cut away to reveal the shell (228) of the outer optic (202) underlying the plurality of concave panels (226). In some embodiments, each of the plurality of concave panels (226) has a wedge shape.

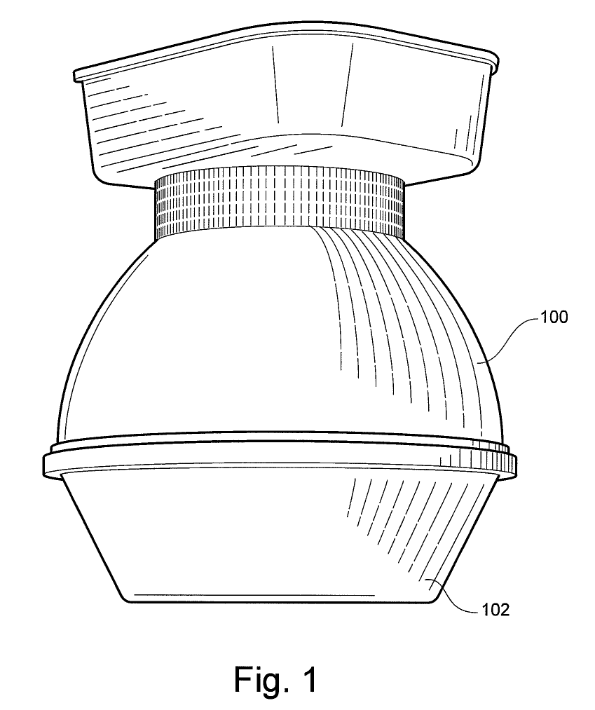

In some embodiments and as illustrated in FIGS. 1-6, a luminaire of the present invention has an open design wherein a protective lens does not enclose or seal the interior of the outer optic from the outside or ambient environment. An open, flow through design can assist in precluding or inhibiting the build up of dirt within the luminaire thereby permitting the luminaire to demonstrate an advantageous luminaire dirt depreciation factor (LDD). In other embodiments, a luminaire of the present invention comprises a protective lens which encloses or seals the interior of the outer optic from the outside environment.

In some embodiments, wherein the luminaire has an open design, the outer optic and/or at least one inner optic comprise a radiation transmissive protective covering. In one embodiment, for example, a reflective outer optic comprises a radiation transmissive protective covering over the interior reflective surface of the outer optic. In some embodiments described herein, the interior reflective surface comprises specular enhanced aluminum panels hermetically sealed between the shell of the outer optic and a protective cover such glass, including but not limited to, borosilicate glass. In some embodiments, protective constructions for interior reflective surfaces of the outer optic comprise those provided in U.S. patent application Ser. No. 11/623,487 which is hereby incorporated by reference in its entirety.

Moreover, in another embodiment, a reflective inner optic comprises a protective covering over the reflective surface of the inner optic. Protective coverings for inner and outer optics of the present invention can comprise any material that does not substantially impair the ability of the inner and outer optics to perform their intended functions. In some embodiments, a protective covering comprises glass or polymeric materials. In one embodiment, a glass suitable for a protective covering comprises borosilicate glass.

Reflective inner and outer optics of the present invention can comprise any reflective material known to those of skill in the art as being suitable for use in reflective optics. In one embodiment, a reflective material for use in inner and outer optics of the present invention comprises polished metals such as, but not limited to, polished aluminum. In some embodiments a reflective material for use in inner and outer optics of the present invention comprises MIRO 4. In some embodiments, the reflectivity of inner and outer optics can be further enhanced by the application of reflective coatings, including reflective paints, or other reflective compositions.

Moreover, refractive inner and outer optics of the present invention can comprise any refractive material suitable for directing light in a manner consistent with embodiments described herein. In some embodiments, a refractive optic comprises a biconvex lens, a planoconvex lens, a planoconcave lens, or a biconcave lens. In other embodiments, a refractive optic comprises a positive meniscus lens or a negative meniscus lens. In some embodiments, a refractive optic comprises one or a plurality of prismatic structures. In one embodiment, a prismatic structure comprises Fresnel prisms. In some embodiments, one or a plurality of prismatic structures are present on at least one surface of an inner and/or outer optic.

Additionally, luminaires of the present contemplate any suitable light source known to one of skill in the art. In some embodiments, a light source comprises a HID lamp including metal halide lamps, high pressure sodium lamps, and mercury vapor lamps. In some embodiments, a HID lamp has any wattage up to 1000 W. In other embodiments, a HID lamp has a wattage greater than 1000 W. In another embodiment, a light source comprises a compact fluorescent lamp. In some embodiments, a compact fluorescent lamp has a wattage of 32 W, 42 W or 57 W.

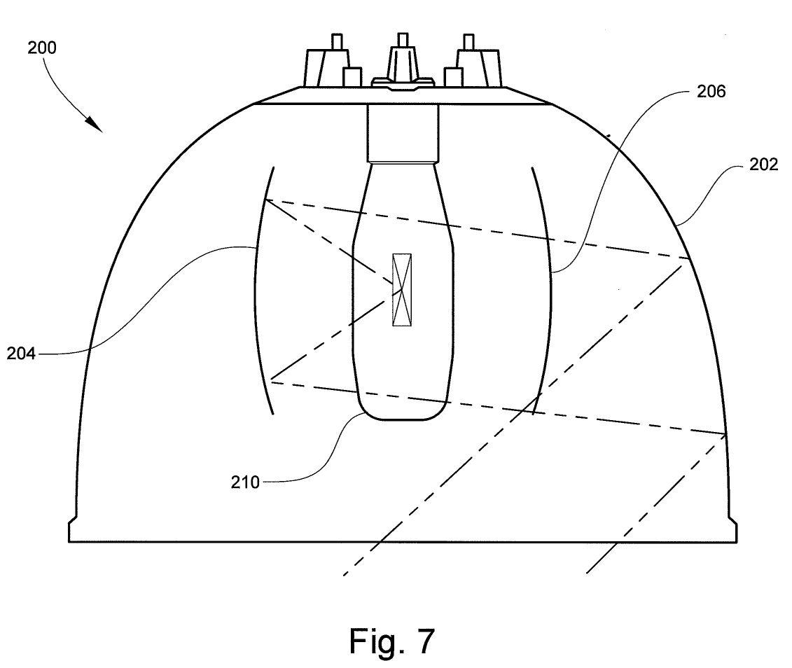

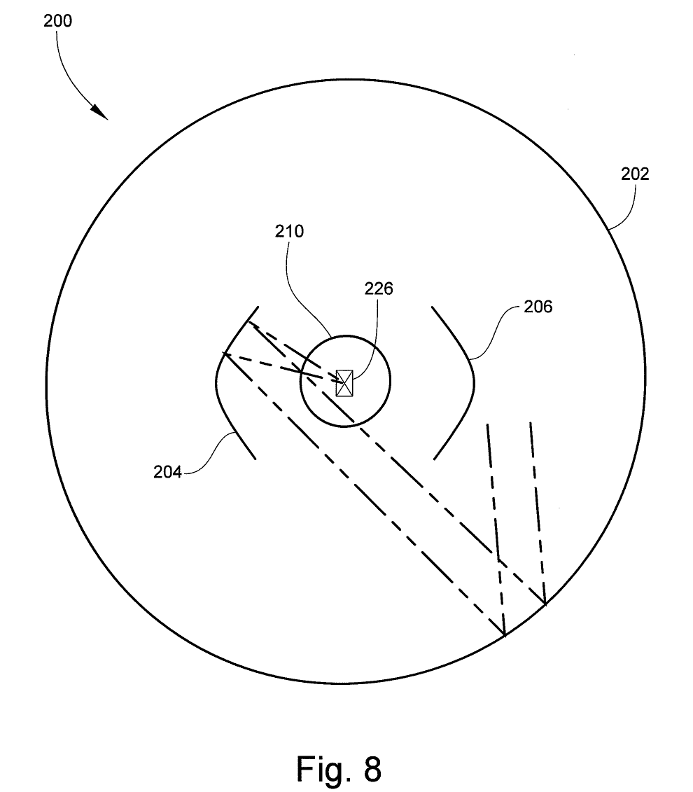

Referring once again to the figures, FIG. 7 is an elevational cut away view of the luminaire (200) illustrating an inner optic (204) directing light to the outer optic (202) for providing an asymmetric light distribution from the luminaire (200) according to one embodiment of the present invention. For purposes of clarity in FIGS. 7 and 8, light received and directed by the inner optic (206) is not illustrated. Moreover, light received directly from the light source (210) by the outer optic (202) and subsequently directed by the outer optic (202) is also not shown.

As illustrated in FIG. 7, the inner optic (204) directs light from the light source (210) to the outer optic (202) for reflection out of the luminaire. In order to work in conjunction with the outer optic (202) to provide an asymmetric light distribution, the inner optic, in some embodiments, is adapted to direct light from the light source (210) in a transverse or substantially transverse direction. Moreover, the outer optic (202) is adapted to direct light received from the inner optic (204) and light received directly from the light source (210) (not shown) in a longitudinal or substantially direction out of the luminaire (200).

FIG. 8 is a top cut away view of the luminaire (200) of FIG. 7 and illustrates inner optic (204) directing light to the outer optic (202) for providing an asymmetric light distribution from the luminaire (200) according to one embodiment of the present invention. In providing light from the light source to the outer optic, in some embodiments, the inner optic does not direct light back through the light source. In one embodiment, for example, the at least one inner optic does not direct light back through the arc tube of a high intensity discharge (HID) lamp, such as a metal halide lamp, high pressure sodium (HPS) lamp, or a mercury vapor lamp. Directing light back through the arc tube of a HPS lamp with an inner optic, for example, can lead to voltage rises that degrade lamp lifetime. Thus, in some embodiments, such as the ones shown in FIGS. 7 and 8, an inner optic (204) does not direct light from the light source (210) back through the arc tube (226) of the light source (210). A portion of light directed from the inner optic (204) can, but does not have to, pass through the envelope of the light source (210), as shown in FIG. 8.

As provided herein, in some embodiments, an inner optic comprises a continuous reflective surface. In some embodiments, the reflective surface of an inner optic has one or more creases or bends operable to reduce or preclude light normal to the inner optic from being directed back through the arc tube of a light source comprising a HID lamp. In some embodiments, for example, the reflective surface of an inner optic have a V-shaped structure being bent at and angle θ as described herein.

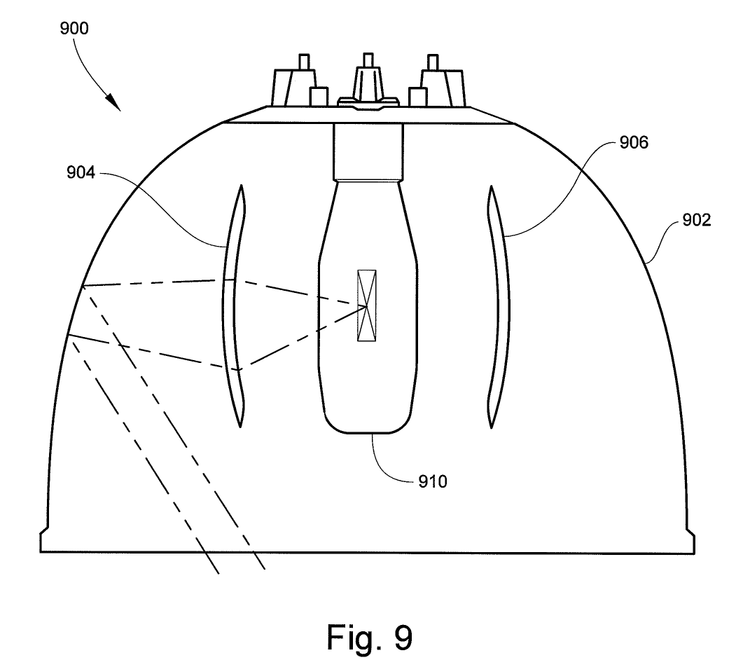

FIG. 9 is an elevational cut away view of a luminaire (900) demonstrating refraction of light from the light source (910) by a refractive inner optic (904) and subsequent reflection of the light by the outer optic (902) to provide an asymmetric light distribution according to one embodiment of the present invention. For purposed of clarity, light refracted by inner optic (906) is not shown. Moreover, light received directly from the light source (910) by the outer optic (902) and subsequently directed by the outer optic (902) is also not shown.

As demonstrated in FIGS. 7 through 9, luminaires, according to some embodiments of the present invention, provide an asymmetric light distribution without the use of shields or other light blocking apparatus. As a result, luminaires of the present invention are operable to overcome the lighting inefficiencies of prior lighting systems which use shields to produce an asymmetric distribution of light.

In addition to providing luminaires, the present invention also provides methods of lighting a surface. In one embodiment, a method of lighting a surface comprises providing a luminaire comprising a light source, an outer optic, and at least one inner optic at least partially positioned within the outer optic, directing to the surface a first portion of light from the light source with the outer optic, and directing to the surface a second portion of light from the light source with the inner optic and the outer optic, wherein at least one of the first portion of directed light and the second portion of directed light is asymmetrically distributed over the surface. In some embodiments, a surface comprises a roadway, sidewalk, parking lot, athletic field or residential area. In another embodiment, a surface comprises an indoor or outdoor work area.

In another embodiment, the present invention provides a method of changing the asymmetric light distribution of a luminaire on a surface. In one embodiment, a method of changing the asymmetric light distribution of a luminaire on a surface comprises providing a luminaire comprising a light source, an outer optic, and at least one inner optic at least partially positioned within the outer optic, adjusting the at least one inner optic, directing to the surface a first portion of light from the light source with the outer optic, and directing to the surface a second portion of light from the light source with the inner optic and the outer optic, wherein at least one on the first portion of directed light and the second portion of directed light is asymmetrically distributed over the surface.

In some embodiments, adjusting the at least one inner optic comprises longitudinally adjusting the inner optic. In another embodiment, adjusting the at least one inner optic comprises laterally adjusting the inner optic. In a further embodiment, adjusting the at least one inner optic comprises radially adjusting the inner optic. In one embodiment, adjusting the at least one inner optic comprises a combination of longitudinal, lateral, and or radial adjustment.

Luminaires according to embodiments of the present invention can be used in a variety of applications. In some embodiments, luminaires of the present invention can be used in outdoor lighting applications, including roadway, parking lot, and sidewalk applications as well as athletic field and residential area applications. In other embodiments, luminaires of the present invention can be used in indoor lighting applications, including warehouse lighting and workspace lighting applications.

Various embodiments of the invention have been described in fulfillment of the various objectives of the invention. It should be recognized that these embodiments are merely illustrative of the principles of the present invention. Numerous modifications and adaptations thereof will be readily apparent to those of skill in the art without departing from the spirit and scope of the invention.

That which is claimed is:

1. A luminaire comprising:
a light source;
an outer optic;
and at least one inner optic at least partially positioned within the outer optic, the outer optic adapted to direct a first portion of light received from the light source and adapted to direct a second portion of light received from the inner optic resulting in an asymmetric light distribution from the luminaire.

2. The luminaire of claim 1, wherein the at least one inner optic is positioned between the light source and the outer optic.

3. The luminaire of claim 1, wherein the at least one inner optic comprises a reflector, refractor, or combination thereof.

4. The luminaire of claim 1, wherein the outer optic comprises a reflector, refractor, or combination thereof.

5. The luminaire of claim 1, wherein the outer optic comprises a plurality of concave panels.

6. The luminaire system of claim 1, wherein the light source is positioned within the outer optic.

7. The luminaire of claim 1, wherein the at least one inner optic comprises a plurality of inner optics.

8. The luminaire of claim 1, wherein the at least one inner optic is adapted to direct light from the light source in a substantially transverse direction.

9. The luminaire of claim 1, wherein the outer optic is adapted to direct the first portion of light received from the light source and the second portion of light received from the at least one inner optic out of the luminaire.

10. The luminaire of claim 1, wherein the at least one inner optic is positioned partially outside of the outer optic.

11. The luminaire of claim 1, wherein the at least one inner optic is adjustable.

12. The luminaire of claim 11, wherein the at least one inner optic is adjustable longitudinally, laterally, or radially.

13. The luminaire of claim 1, wherein the luminaire is open to the ambient environment.

14. A luminaire comprising:
a light source;
an outer optic; and
a plurality of inner optics at least partially positioned within the outer optic, the outer optic adapted to direct a first portion of light received from the light source and adapted to direct a second portion of light received from the plurality of inner optics resulting in an asymmetric light distribution from the luminaire.

15. The luminaire of claim 14, wherein the plurality of inner optics are positioned between the light source and the outer optic.

16. The luminaire of claim 14, wherein the plurality of inner optics are adapted to direct light from the light source in a substantially transverse direction.

17. The luminaire of claim 14, wherein the outer optic is adapted to direct the first portion of light received from the light source and the second portion of light received from the plurality of inner optics in a substantially longitudinal direction.

19. The luminaire of claim 14, wherein the plurality of inner optics surround less than about 180° of the circumference of the light source.

20. The luminaire of claim 14, wherein the plurality of inner optics surround less than about 90° of the circumference of the light source.

21. The luminaire of claim 14, wherein the plurality of inner optics are reflectors.

22. The luminaire of claim 14, wherein at least one of the plurality of inner optics is adjustable.

23. The luminaire of claim 22, wherein the at least one adjustable inner optic is at least one of longitudinally adjustable, laterally adjustable, or radially adjustable.

24. The luminaire of claim 14, wherein at least one of the plurality of inner optics is bent at an angle θ.

25. The luminaire of claim 24, where the angle θ is greater than about 90°.

26. The luminaire of claim 14, wherein the outer optic comprises a plurality of reflective concave panels.

27. A method of lighting a surface comprising:
providing a luminaire comprising a light source, an outer optic, and at least one inner optic at least partially disposed within the outer optic;
directing to the surface a first portion of light from the light source with the outer optic; and
directing to the surface a second portion of light from the light source with the inner optic and the outer optic,
wherein at least one of the first portion of directed light and the second portion of directed light is asymmetrically distributed over the surface.

28. The method of claim 27, wherein the surface comprises a roadway.

29. A method of changing the asymmetric light distribution of a luminaire comprising:
providing a luminaire comprising a light source, an outer optic, and at least one inner optic at least partially positioned within the outer optic;
adjusting the at least one inner optic;
directing to the surface a first portion of light from the light source with the outer optic; and
directing to the surface a second portion of light from the light source with the inner optic and the outer optic,
wherein at least one of the first portion of directed light and the second portion of directed light is asymmetrically distributed over the surface.

30. The method of claim 29, wherein adjusting comprises longitudinally adjusting, laterally adjusting, radially adjusting, or a combination thereof.
